(19) United States
(12) Patent Application Publication
(10) Pub. No.: US 2023/0218995 A1
(43) Pub. Date: Jul. 13, 2023

(54) Efficient social networking for online games

(71) Applicant: TECHNOLOGIES HUB LTD., Birkirkara (MT)

(72) Inventors: Lior Cohen, Essen (DE); Motty Idzikowski, Bitzaron (IL)

(21) Appl. No.: 17/572,666

(22) Filed: Jan. 11, 2022

(51) Int. Cl. A63F 13/53; A63F 13/35

(52) U.S. Cl. CPC A63F 13/53; A63F 13/35

(57) ABSTRACT

A system for use with players playing on respective clients includes a processor configured to receive, from a first client, a notification message indicating a win by the player playing on the first client, to verify, in response to receiving the notification message, that one or more predefined notification criteria are satisfied, to communicate the notification message to a subset of the clients in response thereto, thereby causing the subset of the clients to display a notification of the win, to receive, from a second client, a reaction message indicating a reaction to the notification by the player playing on the second client, to verify, in response to receiving the reaction message, that one or more predefined reaction criteria are satisfied, and to communicate the reaction message to the first client in response thereto, thereby causing the first client to display the reaction.

### FIELD OF THE INVENTION

The present invention is related to the field of computer-network communications.

### BACKGROUND

Online games are computer games played over computer network, such as the Internet.

### SUMMARY OF THE INVENTION

There is provided, in accordance with some embodiments of the present invention, a system for use with a plurality of players playing respective online games on respective clients. The system includes a network interface and a processor. The processor is configured to receive via the network interface over a computer network, from a first client of the clients, a notification message indicating a win by the player playing on the first client. The processor is further configured to verify, in response to receiving the notification message, that one or more predefined notification criteria are satisfied. The processor is further configured to communicate the notification message over the computer network to a subset of the clients in response to verifying that the notification criteria are satisfied, thereby causing the subset of the clients to display a notification of the win. The processor is further configured to receive over the computer network, from a second client of the subset of the clients, a reaction message indicating a reaction to the notification by the player playing on the second client. The processor is further configured to verify, in response to receiving the reaction message, that one or more predefined reaction criteria are satisfied. The processor is further configured to communicate the reaction message to the first client in response to verifying that the reaction criteria are satisfied, thereby causing the first client to display the reaction.

In some embodiments, the notification criteria include a criterion that no previous notification message was communicated by the processor within a predefined threshold amount of time.

In some embodiments, the notification criteria include a criterion that a size of the win exceed at least one of one or more predefined thresholds.

In some embodiments, the processor is further configured to select the subset of the clients based on respective locations at which the clients are located.

In some embodiments, the processor is configured to select the subset of the clients by, for each of at least some of the locations, selecting those of the clients located at the location with a probability that depends on a current time at the location.

In some embodiments, the processor is further configured to compute the probability, prior to selecting the subset of the clients, based on a number of previous reaction messages communicated from the location during a recurring period of time that includes the current time.

In some embodiments, the reaction criteria include a criterion that the reaction message is received within a predefined interval of the communicating of the notification message.

In some embodiments, the reaction criteria include a criterion that a type of the reaction is one of a predefined plurality of types.

In some embodiments, the reaction criteria include a criterion that no previous reaction message was communicated by the processor to the first client within a predefined threshold amount of time.

There is further provided, in accordance with some embodiments of the present invention, a method for use with a plurality of players playing respective online games on respective clients. The method includes receiving by a server over a computer network, from a first client of the clients, a notification message indicating a win by the player playing on the first client. The method further includes, in response to receiving the notification message, verifying that one or more predefined notification criteria are satisfied. The method further includes, in response to verifying that the notification criteria are satisfied, communicating the notification message over the computer network to a subset of the clients, thereby causing the subset of the clients to display a notification of the win. The method further includes receiving over the computer network, from a second client of the subset of the clients, a reaction message indicating a reaction to the notification by the player playing on the second client. The method further includes, in response to receiving the reaction message, verifying that one or more predefined reaction criteria are satisfied. The method further includes, in response to verifying that the reaction criteria are satisfied, communicating the reaction message to the first client, thereby causing the first client to display the reaction.

There is further provided, in accordance with some embodiments of the present invention, a computer software product for use with a plurality of players playing respective online games on respective clients, the computer software product including a tangible non-transitory computer-readable medium in which program instructions are stored. The instructions, when read by a processor, cause the processor to receive over a computer network, from a first client of the clients, a notification message indicating a win by the player playing on the first client. The instructions further cause the processor to verify, in response to receiving the notification message, that one or more predefined notification criteria are satisfied. The instructions further cause the processor to communicate the notification message over the computer network to a subset of the clients in response to verifying that the notification criteria are satisfied, thereby causing the subset of the clients to display a notification of the win. The instructions further cause the processor to receive over the computer network, from a second client of the subset of the clients, a reaction message indicating a reaction to the notification by the player playing on the second client. The instructions further cause the processor to verify, in response to receiving the reaction message, that one or more predefined reaction criteria are satisfied. The instructions further cause the processor to communicate the reaction message to the first client in response to verifying that the reaction criteria are satisfied, thereby causing the first client to display the reaction.

The present invention will be more fully understood from the following detailed description of embodiments thereof, taken together with the drawings, in which:

### BRIEF DESCRIPTION OF THE DRAWINGS

FIG. 1 is a schematic illustration of a system for providing efficient social networking for online games, in accordance with some embodiments of the present invention;

FIG. 2 is a flow diagram for an example algorithm for selectively communicating win notifications, in accordance with some embodiments of the present invention;

FIG. 3 is a flow diagram for an example algorithm for selectively communicating reactions to win notifications, in accordance with some embodiments of the present invention;

FIG. 4 is a flow diagram for a checking step, in accordance with some embodiments of the present invention;

FIG. 5 is a flow diagram for a client-subset-selecting step, in accordance with some embodiments of the present invention; and

FIG. 6 is a flow diagram for a checking step, in accordance with some embodiments of the present invention.

### DETAILED DESCRIPTION OF EMBODIMENTS

### Overview

Embodiments of the present invention provide a server configured to provide efficient social networking between players of online games on respective client computers connected to a computer network. In particular, when a player wins an amount of money, the server may send a notification of the win to other players. The other players may then react to the win, and the reactions may be sent from the server to the winning player. Advantageously, the notifications and reactions are communicated selectively, in that the timing, content, and volume of these messages are carefully controlled. Thus, embodiments of the present invention help conserve bandwidth on the computer network, reduce the computational load on the server and clients, and provide an improved social-networking experience.

For example, the server may refrain from notifying a first player of a second player's win unless the size of the win exceeds a predefined threshold, which may be specific to the currency in which the first player is playing. As another example, the server may refrain from communicating a notification or a reaction unless a predefined threshold amount of time has passed since the communication of the previous notification or reaction. As yet another example, the server may refrain from sending a notification to a player for whom the local time belongs to a predefined recurring period of time in which players are less likely to react to notifications.

### System Description

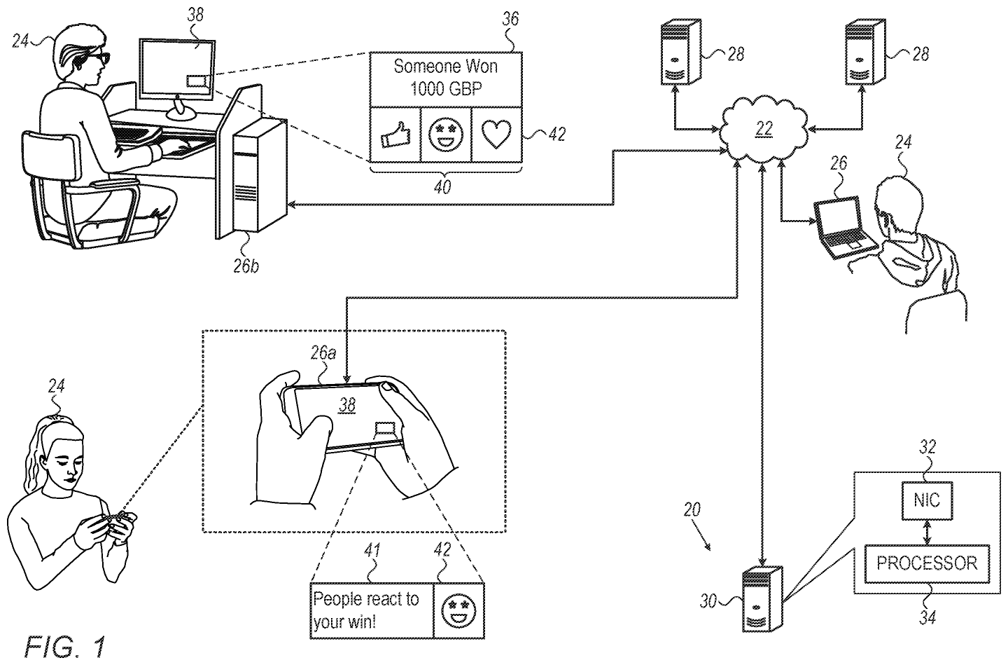

Reference is initially made to FIG. 1, which is a schematic illustration of a system 20 for providing efficient social networking for online games, in accordance with some embodiments of the present invention.

FIG. 1 depicts a plurality of players 24 playing respective online games on respective clients 26, each of which may comprise a desktop computer, a laptop, a mobile phone, or any other suitable computing device. By wagering on the games, players 24 may win sums of money. Clients 26 (and players 24) may be located at any number of different locations and may play in any number of different currencies.

Typically, the online games are serviced by respective gaming servers 28, which communicate with clients 26 over a computer network 22 such as the Internet. Gaming servers 28 may be operated by any number of different operators.

System 20 comprises at least one server 30 comprising a network interface 32, such as a network interface controller (NIC), and a processor 34. Processor 34 is configured to communicate with clients 26, over computer network 22, via network interface 32.

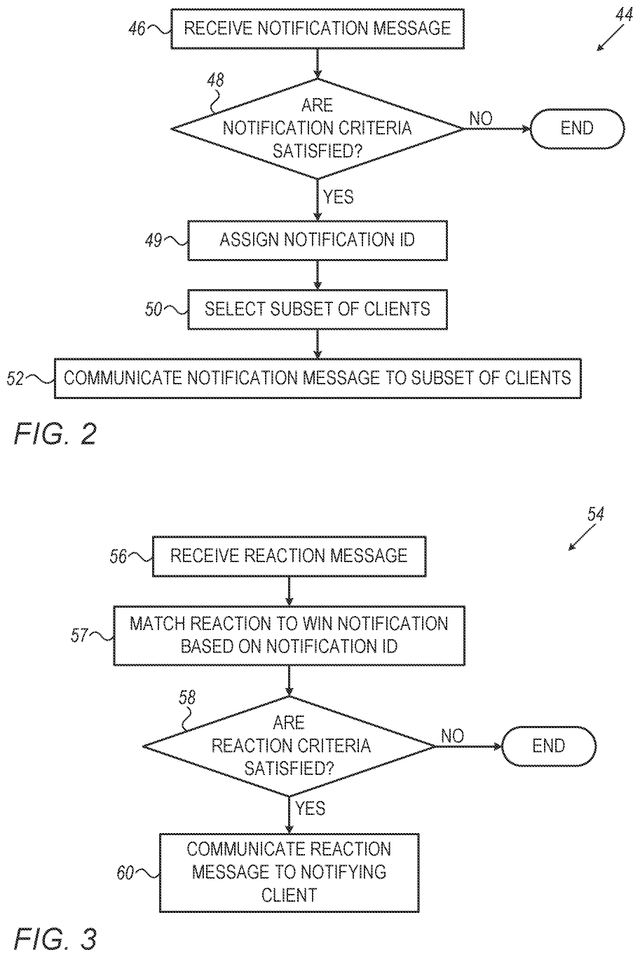

In particular, as further described below with reference to FIG. 2, processor 34 is configured to receive, from any notifying client 26a, a notification message indicating a win by the player playing on client 26a. For example, the notification message may indicate the size of the win (i.e., the amount of money won) and a socket ID identifying the socket connection between processor 34 and client 26a. Based on the socket ID, the processor may look up additional information associated with client 26a, which the processor recorded when opening the socket connection. Such additional information may include, for example, the location of client 26a, the currency in which the game on client 26a is being played, the language in which the game is being played, and/or the operator of the server 28 servicing the game. The processor may further assign a notification ID to the notification message.

Subsequently, the processor may decide to send the notification message to a subset of the clients. In response thereto, the processor may communicate the notification message to the subset, thereby causing each client 26b in the subset to display a notification of the win. Prior to communicating the notification message, the processor may add information to, and/or remove information from, the message. For example, the processor may add the currency of the win and the notification ID, and/or remove the socket ID.

Typically, each client 26b is configured to display the win notification in a widget 36. (Typically, widget 36 is placed at the edge of the display 38 of the client, so as to minimize interference with the game that is being played on client 26b.) Typically, the notification includes the amount and currency of the win. Optionally, the notification may also include information relating to the player 24 who executed the win, such as the player's location, provided that this information is included in the notification message from processor 34.

Typically, in addition to displaying the notification, client 26b displays a graphical user interface (GUI) 40 including one or more icons 42. For example, GUI 40 may be displayed beneath or beside the win notification in widget 36. The player playing on client 26b may thus react to the notification by selecting one of icons 42. Alternatively or additionally, the player may react to the notification by selecting or entering next, such as “Well done!”

As further described below with reference to FIG. 3, processor 34 is further configured to receive, from any client 26b that was notified of the win, a reaction message indicating a reaction to the win by the player playing on client 26b. For example, the reaction message may include a description of a selected icon 42 and/or text selected or entered by the player, along with the notification ID of the notification to which the reaction pertains. In response to receiving the reaction message, the processor may decide to communicate the reaction message to notifying client 26a, thereby causing client 26a to display the reaction. Prior to communicating the reaction message, the processor may add information to, and/or remove information (e.g., the notification ID) from, the message.

Typically, notifying client 26a is configured to display the reaction (e.g., the selected icon 42) in a widget 41. (Typically, widget 41 is placed at the edge of display 38, as described above for widget 36.) Optionally, widget 41 may further contain explanatory text, as shown in FIG. 1. (Optionally, the explanatory text may be contained in the reaction message communicated to the notifying client.) In some embodiments, as each new reaction message is received, the icon currently in widget 41 moves away from the widget and becomes progressively smaller, and the icon indicated by the newly-received reaction message occupies widget 41 in its stead.

Each of the aforementioned messages may specify information in any suitable format, such as JavaScript Object Notation (JSON). For example:

(i) A notification message sent to server 30 may include a JSON object including a first name-value pair for the size of the win and a second name-value pair for the socket ID.

(ii) A notification message sent from the server may include a JSON object including a first name-value pair for the size of the win, a second name-value pair for the currency of the win, and a third name-value pair for the notification ID.

(iii) A reaction message sent to the server may include a JSON object including a first name-value pair for a description of the selected icon and a second name-value pair for the notification ID.

(iv) A reaction message sent from the server may include a JSON object including a single name-value pair for a description of the selected icon.

In general, processor 34 may be embodied as a single processor, or as a cooperatively networked or clustered set of processors. For example, processor 34 may be embodied as a cooperatively networked set of processors belonging to respective servers 30 belonging, for example, to a cloud-computing service.

The functionality of processor 31 may be implemented solely in hardware, e.g., using one or more fixed-function or general-purpose integrated circuits, Application-Specific Integrated Circuits (ASICs), and/or Field-Programmable Gate Arrays (FPGAs). Alternatively, this functionality may be implemented at least partly in software. For example, processor 34 may be embodied as a programmed processor comprising, for example, a central processing unit (CPU) and/or a Graphics Processing Unit (GPU). Program code, including software programs, and/or data may be loaded for execution and processing by the CPU and/or GPU. The program code and/or data may be downloaded to the processor in electronic form, over a network, for example. Alternatively or additionally, the program code and/or data may be provided and/or stored on non-transitory tangible media, such as magnetic, optical, or electronic memory. Such program code and/or data, when provided to the processor, produce a machine or special-purpose computer, configured to perform the tasks described herein.

### Example Algorithms

Reference is now made to FIG. 2, which is a flow diagram for an example algorithm 44 for selectively communicating win notifications, in accordance with some embodiments of the present invention. In some embodiments, algorithm 44 is executed by processor 34 (FIG. 1).

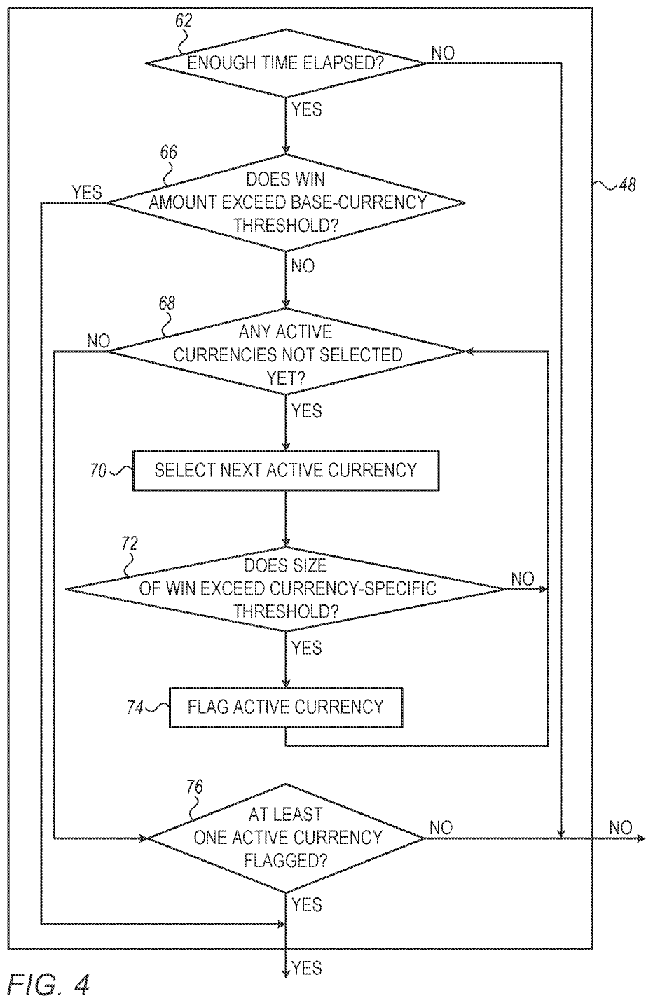

At a notification-receiving step 46, the processor receives a notification message from one of clients 26, as described above with reference to FIG. 1. In response to receiving the notification message, the processor checks, at a checking step 48, whether one or more predefined notification criteria are satisfied. For example, as further described below with reference to FIG. 4, the notification criteria may include one or both of the following criteria:

(i) No previous notification message was communicated by the server within a predefined threshold amount of time.

(ii) The size of the win (i.e., the amount of money won) exceeds at least one of one or more predefined thresholds.

If the notification criteria are not all satisfied, algorithm 44 ends. Otherwise, in response to verifying that the notification criteria are satisfied, the processor assigns a notification ID to the notification at an ID-assigning step 49.

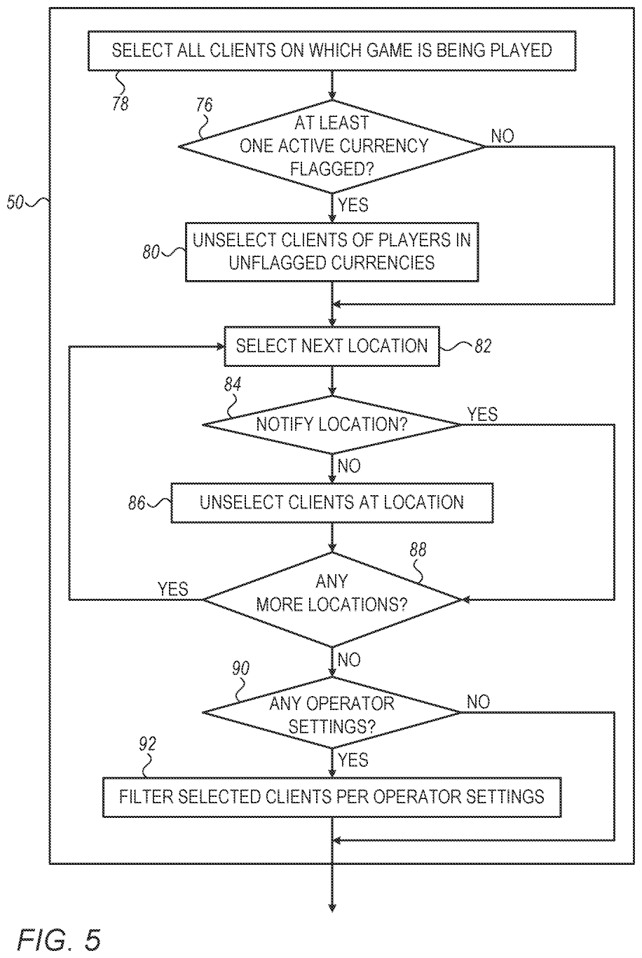

Subsequently to assigning a notification ID, the processor selects a subset of the clients at a client-subset-selecting step 50. For example, the processor may select the subset of the clients based on the respective locations at which the clients are located. For example, as further described below with reference to FIG. 5, for each of at least some of the locations, the processor may select those of the clients located at the location with a probability that depends on the local time at the location.

Subsequently, at a notification-communicating step 52, the processor communicates the notification message (with any appropriate modifications) to the subset of the clients, thereby causing the subset of the clients to display the notification as described above with reference to FIG. 1.

Reference is now made to FIG. 3, which is a flow diagram for an example algorithm 54 for selectively communicating reactions to win notifications, in accordance with some embodiments of the present invention. In some embodiments, algorithm 54 is executed by processor 34 (FIG. 1).

At a reaction-receiving step 56, the processor receives a reaction message indicating a reaction to a win notification. Subsequently, at a matching step 57, the processor matches the reaction to the notification, based on the notification ID contained in the reaction message.

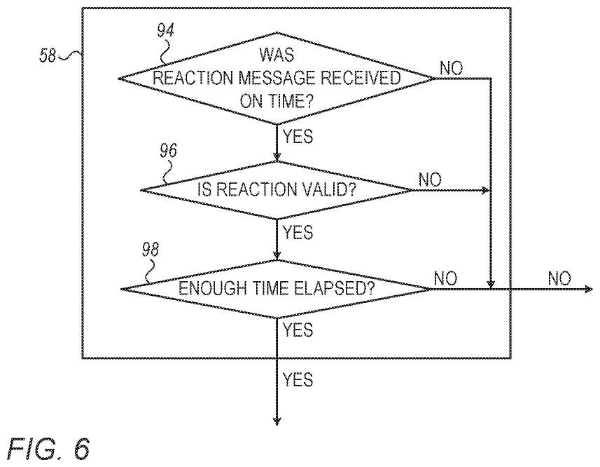

Next, the processor checks, at another checking step 58, whether one or more predefined reaction criteria are satisfied. For example, as further described below with reference to FIG. 6, the reaction criteria may include any one or more of the following criteria:

(i) The reaction message is received within a predefined interval of the communicating of the notification message.

(ii) The reaction is valid, i.e., the type of the reaction is one of a predefined plurality of types. For example, the icons shown in GUI 40 (FIG. 1) may be described by the terms “thumbs-up,” “smile,” and “like,” respectively. If the description of the reaction in the reaction message does not match one of these terms, the reaction may be invalid. (Thus, hackers may be inhibited from communicating invalid reaction types.)

(iii) No previous reaction message was communicated by the server to the notifying client (i.e., the client that sent the win notification) within a predefined threshold amount of time. (Thus, the winning player is not inundated with reactions.)

If the reaction criteria are not all satisfied, algorithm 54 ends. Otherwise, in response to verifying that the reaction criteria are satisfied, the processor, at a reaction-communicating step 60, communicates the reaction message (with any appropriate modifications) to the notifying client. The communication of the reaction message causes the client to display the reaction as described above with reference to FIG. 1.

Reference is now made to FIG. 4, which is a flow diagram for checking step 48 of algorithm 44 (FIG. 2), in accordance with some embodiments of the present invention.

Typically, the notification criteria include a criterion that no previous notification message was communicated by the processor within a predefined threshold amount of time. The processor may assess whether this criterion is satisfied at an assessing step 62. For example, if the most recent notification message was sent at time t0, the processor may compare t1-t0 to the predefined threshold, t1 being the current time.

If the criterion is not satisfied, checking step 48 returns a negative output. Otherwise, the processor may check whether one or more other criteria are satisfied. Typically, these criteria include a criterion that the size of the win exceed at least one of one or more predefined thresholds. In some embodiments, these thresholds include one or more currency-specific thresholds corresponding to different respective currencies.

For example, in some embodiments, following assessing step 62, the processor assesses, at another assessing step 66, whether the win amount exceeds a predefined threshold amount in a base currency, referred to herein as a base-currency threshold. (It is noted that the base currency need not necessarily be an “active currency,” i.e., there need not necessarily be any players currently playing in the base currency.) In performing this assessment, the processor may perform a currency conversion in case the currency of the win is different from the base currency. In other words, the processor may convert the win amount to the base currency or the base-currency threshold to the currency of the win.

If the win amount exceeds the base-currency threshold, checking step 48 returns a positive output. Otherwise, the processor assesses, at another assessing step 68, whether any active currencies, other than the base currency, have yet to be selected. (As noted above, an active currency is any currency in which at least one player is currently playing.) If yes, the processor selects the next active currency at a currency-selecting step 70. Next, the processor assesses, at another assessing step 72, whether the size of the win (i.e., the amount of money that was won) exceeds the currency-specific threshold corresponding to the selected currency. (If a currency conversion is required, the processor performs this conversion.) If yes, the selected currency is flagged at a flagging step 74. Subsequently, or if the win amount does not exceed the currency-specific threshold, the processor returns to assessing step 68.

Upon ascertaining, at assessing step 68, that no active currencies have yet to be selected, the processor assesses, at another assessing step 76, whether at least one active currency was flagged. If yes, checking step 48 returns a positive output; otherwise, checking step 48 returns a negative output.

Reference is now made to FIG. 5, which is a flow diagram for client-subset-selecting step 50 (FIG. 2), in accordance with some embodiments of the present invention.

In some embodiments, client-subset-selecting step 50 begins with an initial selecting step 18, at which the processor selects all the clients on which the game in which the win was achieved is being played. (For example, if the win was achieved in Game XYZ, the processor may select all the client on which Game XYZ is being played.) In other embodiments, the processor initially selects a larger subset of the clients, including clients on which one or more other games are being played.

Next, at assessing step 76, the processor assesses whether at least one active currency was flagged. If yes, the processor, at an unselecting step 80, unselects the clients of players in those currencies that are not flagged. Subsequently, or if no active currencies are flagged, the processor, at a location-selecting step 82, selects a location at which at least one of the selected clients is located. For example, the processor may select a time zone, a country, or a time zone within a particular country.

Subsequently to selecting a location, the processor decides, at a deciding step 84, whether to notify the location (i.e., the clients at the location) of the win. For example, the processor may load a predefined lookup table specifying respective notification probabilities for multiple locations and multiple recurring time periods. (Each time period may have any suitable length, such as 30 minutes or one hour, and may be specified in Coordinated Universal Time (UTC) or the local time at the location.) The processor may then decide whether to notify the location based on the probability p specified for the location and the recurring time period to which the current time belongs. For example, the processor may generate a random number between 0 and 1. Subsequently, the processor may decide to notify the location in response to the random number being less than p (or in response to the random number being greater than 1−p). Alternatively, each of the notification probabilities may be zero or one, such that no generation of random numbers is required.

By way of illustration, Table 1 below shows a portion of an example lookup table specifying notification probabilities for two recurring time periods and several different countries:

TABLE 1

| Time (UTC) | Location | Probability |
|---|---|---|
| 00:00-00:59 | Colombia | 0.8 |
| 00:00-00:59 | Peru | 0.8 |
| 00:00-00:59 | United Kingdom | 1 |
| 00:00-00:59 | Italy | 1 |
| 00:00-00:59 | Greece | 1 |
| 16:00-16:59 | Colombia | 0.1 |
| 16:00-16:59 | Peru | 0.1 |
| 16:00-16:59 | United Kingdom | 0.8 |
| 16:00-16:59 | Italy | 0.8 |
| 16:00-16:59 | Greece | 0.8 |

(Although, in this example, the probability is the same for any two countries in the same time zone, it is noted that probabilities may differ between two countries in the same time zone.)

Given this example, and assuming that the selected location is Colombia and the current time is 00:30 UTC, the processor may decide to notify Colombia if the random number is less than 0.8.

Typically, the processor computes the probability for each location and time period based on the number of reaction messages communicated from the location during the period. (This computation may be performed periodically.) For example, the processor may compute the probability as a function of the average percentage of players at the location who reacted to any win notification. This average may be computed over a preceding interval of time (e.g., over the preceding month) or over a number of preceding win notifications. Thus, for example, on average, a relatively large percentage of the players reacted, the processor may compute a probability of one.

If the processor decides not to notify the location, the processor unselects the clients in the location at another unselecting step 86. Subsequently, or if the processor decides to notify the location, the processor checks, at another checking step 88, whether there are any more locations at which at least one selected player is located. If yes, the processor returns to location-selecting step 82.

Subsequently to ascertaining, at checking step 88, that no more locations remain to be selected, the processor checks, at another checking step 90, whether there are any settings for the operator of the server servicing the game in which the win was achieved. If yes, the processor, at a filtering step 92, filters the selected clients per the operator settings.

For example, it will be supposed the win was achieved in Game XYZ serviced by a server operated by Operator ABC. The settings for Operator ABC may specify that only clients serviced by a server operated by Operator ABC should be notified of the win. The processor may therefore filter out (i.e., unselect) other clients, including those on which Game XYZ is being played under operation of a different operator.

Subsequently to performing filtering step 92, or if there are no operator settings, the processor proceeds to notification-communicating step 52 (FIG. 2).

It is noted that the steps of client-subset-selecting step 50 may be performed in any suitable order. For example, checking step 90 and filtering step 92 may be performed prior to assessing step 76.

Reference is now made to FIG. 6, which is a flow diagram for checking step 58 (FIG. 3), in accordance with some embodiments of the present invention.

In some embodiments, checking step 58 begins with an assessing step 94, at which the processor assesses whether the reaction message was received within a predefined interval of the sending of the notification message to which the reaction pertains. If not, checking step 58 returns a negative output. Otherwise, the processor assesses, at another assessing step 96, whether the reaction is valid. If not, checking step 58 returns a negative output. Otherwise, the processor assesses, at another assessing step 98, whether the amount of time from the most recent communication of a reaction message to the notifying client exceeds a predefined threshold. If not, checking step 58 returns a negative output; otherwise, checking step 58 returns a positive output.

It is noted that the steps of checking step 58 may be performed in any suitable order.

It will be appreciated by persons skilled in the art that the present invention is not limited to what has been particularly shown and described hereinabove. Rather, the scope of embodiments of the present invention includes both combinations and subcombinations of the various features described hereinabove, as well as variations and modifications thereof that are not in the prior art, which would occur to persons skilled in the art upon reading the foregoing description. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A system for use with a plurality of players playing respective online games on respective clients, the system comprising:
a network interface; and
a processor, configured to:
receive via the network interface over a computer network, from a first client of the clients, a notification message indicating a win by the player playing on the first client,
in response to receiving the notification message, verify that one or more predefined notification criteria are satisfied,
in response to verifying that the notification criteria are satisfied, communicate the notification message over the computer network to a subset of the clients, thereby causing the subset of the clients to display a notification of the win,
receive over the computer network, from a second client of the subset of the clients, a reaction message indicating a reaction to the notification by the player playing on the second client,
in response to receiving the reaction message, verify that one or more predefined reaction criteria are satisfied, and
in response to verifying that the reaction criteria are satisfied, communicate the reaction message to the first client, thereby causing the first client to display the reaction.

2. The system according to claim 1, wherein the notification criteria include a criterion that no previous notification message was communicated by the processor within a predefined threshold amount of time.

3. The system according to claim 1, wherein the notification criteria include a criterion that a size of the win exceed at least one of one or more predefined thresholds.

4. The system according to claim 1, wherein the processor is further configured to select the subset of the clients based on respective locations at which the clients are located.

5. The system according to claim 4, wherein the processor is configured to select the subset of the clients by, for each of at least some of the locations, selecting those of the clients located at the location with a probability that depends on a current time at the location.

6. The system according to claim 5, wherein the processor is further configured to, prior to selecting the subset of the clients, compute the probability based on a number of previous reaction messages communicated from the location during a recurring period of time that includes the current time.

7. The system according to claim 1, wherein the reaction criteria include a criterion that the reaction message is received within a predefined interval of the communicating of the notification message.

8. The system according to claim 1, wherein the reaction criteria include a criterion that a type of the reaction is one of a predefined plurality of types.

9. The system according to claim 1, wherein the reaction criteria include a criterion that no previous reaction message was communicated by the processor to the first client within a predefined threshold amount of time.

10. A method for use with a plurality of players playing respective online games on respective clients, the method comprising:
receiving by a server over a computer network, from a first client of the clients, a notification message indicating a win by the player playing on the first client;
in response to receiving the notification message, verifying that one or more predefined notification criteria are satisfied;
in response to verifying that the notification criteria are satisfied, communicating the notification message over the computer network to a subset of the clients, thereby causing the subset of the clients to display a notification of the win;
receiving over the computer network, from a second client of the subset of the clients, a reaction message indicating a reaction to the notification by the player playing on the second client;
in response to receiving the reaction message, verifying that one or more predefined reaction criteria are satisfied; and
in response to verifying that the reaction criteria are satisfied, communicating the reaction message to the first client, thereby causing the first client to display the reaction.

11. The method according to claim 10, wherein the notification criteria include a criterion that no previous notification message was communicated by the server within a predefined threshold amount of time.

12. The method according to claim 10, wherein the notification criteria include a criterion that a size of the win exceed at least one of one or more predefined thresholds.

13. The method according to claim 10, further comprising selecting the subset of the clients based on respective locations at which the clients are located.

14. The method according to claim 13, wherein selecting the subset of the clients comprises, for each of at least some of the locations, selecting those of the clients located at the location with a probability that depends on a current time at the location.

15. The method according to claim 14, further comprising, prior to selecting the subset of the clients, computing the probability based on a number of previous reaction messages communicated from the location during a recurring period of time that includes the current time.

16. The method according to claim 10, wherein the reaction criteria include a criterion that the reaction message is received within a predefined interval of the communicating of the notification message.

17. The method according to claim 10, wherein the reaction criteria include a criterion that a type of the reaction is one of a predefined plurality of types.

18. The method according to claim 10, wherein the reaction criteria include a criterion that no previous reaction message was communicated by the server to the first client within a predefined threshold amount of time.

19. A computer software product for use with a plurality of players playing respective online games on respective clients, the computer software product comprising a tangible non-transitory computer-readable medium in which program instructions are stored, which instructions, when read by a processor, cause the processor to:
receive over a computer network, from a first client of the clients, a notification message indicating a win by the player playing on the first client,
in response to receiving the notification message, verify that one or more predefined notification criteria are satisfied,
in response to verifying that the notification criteria are satisfied, communicate the notification message over the computer network to a subset of the clients, thereby causing the subset of the clients to display a notification of the win,
receive over the computer network, from a second client of the subset of the clients, a reaction message indicating a reaction to the notification by the player playing on the second client,
in response to receiving the reaction message, verify that one or more predefined reaction criteria are satisfied, and
in response to verifying that the reaction criteria are satisfied, communicate the reaction message to the first client, thereby causing the first client to display the reaction.

20. The computer software product according to claim 19, wherein the instructions further cause the processor to select the subset of the clients based on respective locations at which the clients are located.
